(19) United States
(12) Patent Application Publication
(10) Pub. No.: US 2008/0309127 A1
(43) Pub. Date: Dec. 18, 2008

(54) Supporting Device for a Soft Top Compartment Cover of a Convertible

(76) Inventor: Fritz Wegener, Gilching (DE)

Correspondence Address: DICKINSON WRIGHT PLLC, 1875 Eye Street, NW, Suite 1200, WASHINGTON, DC, 20006, US

(21) Appl. No.: 11/995,723

(22) PCT Filed: Jul. 19, 2006
(86) PCT No.: PCT/DE2006/001258

§ 371 Date: Jun. 30, 2008

(30) Foreign Application Priority Data
Jul. 19, 2005 (DE) 102005034222.1

(51) Int. Cl. B60J 7/185; B60J 7/20

(52) U.S. Cl. 296/223; 296/224

(57) ABSTRACT

The invention relates to a supporting device for a soft top compartment cover of a convertible Said supporting device is movably mounted on the vehicle body and can be fixed thereto by means of a locking mechanism. In order to improve the functionality of the supporting device, the locking mechanism comprises two lock units (30, 43) which are disposed on the supporting device and are interconnected so as to be actuated jointly. The first lock unit (30) is used for fastening the supporting device (3) to the vehicle body while the second lock unit (43) is used for attaching the soft top compartment cover (1), which is movably mounted on the supporting device (3), to the supporting device (3).

The invention relates to a supporting device for a convertible top compartment cover of a convertible, which supporting device is mounted movably on the vehicle body and can be fixed on the vehicle body by means of a locking unit.

DE 101 07 079 A1 has disclosed a convertible which, in its rear region, has a supporting device, to the front side of which a convertible top compartment cover is fixedly attached and on the rear side of which a tailgate is mounted movably by means of a bearing device. The supporting device can be adjusted between a closed position and a rearwardly pivoted open position by means of a four-joint mechanism on the vehicle body and, in its closed position, can be locked to the vehicle body by means of a lock device. On each of its two sides, the lock device contains two locks which are spaced apart from each other in the longitudinal direction, are arranged on the supporting device and are connected to a common drive arranged on the supporting device. According to an alternative configuration, the front lock is arranged on the vehicle body and the rear lock is arranged on the supporting device and each lock is assigned its own drive. The tailgate can be locked by means of a tailgate lock which is arranged in the region of the bearing device of the tailgate.

The invention is based on the object of developing a supporting device, which is mentioned at the beginning, together with a locking device in such a manner that its functionality in respect of the locking device is improved.

According to the invention, the object is achieved in the case of the supporting device mentioned at the beginning in that the locking device has two lock units which are connected to each other for common actuation and are arranged on the supporting device, the first lock unit being provided for fixing the supporting device to the vehicle body and the second lock unit being provided for fixing the convertible top compartment cover—which is mounted movably on the supporting device—to the supporting device. The actuation of the two interconnected lock units for the supporting device and for the convertible top compartment cover can therefore be undertaken in a cost-effective and operationally reliable manner by means of a common drive, it being possible for the drive to be arranged, for example, on the supporting device or to be derived from a driving device of the supporting device.

The supporting device or the frame is provided for convertible top compartment covers of convertibles having a convertible hard top or soft top roof, but may also be used in other vehicles.

Advantageous refinements of the invention are indicated in the subclaims.

A preferred mode of operation is produced if, in a closed position of the supporting device, the first lock unit locks the supporting device to the vehicle body and the second lock unit unlocks the convertible top compartment cover. With this configuration, the convertible top compartment cover can be pivoted open about its front bearing axis in relation to the fixed supporting device to function as a trunk flap.

In order to pivot up the front side of the supporting device, the first lock unit is expediently unlocked from the vehicle body and the second lock unit keeps the convertible top compartment cover locked to the supporting device. In this case, the convertible top compartment cover is prevented from swinging up in relation to the supporting device. The swinging-up could be brought about, in particular, by means of a gas-filled compression spring which is provided in order to assist the opening of the convertible top compartment cover, which is used as a trunk flap, and which, when the front side of the convertible top compartment cover is pivoted up, could exceed the decreasing relevant weight component of the convertible top compartment cover.

A coupling device preferably couples the two lock units to each other, with, in particular, a connecting linkage being provided, but it also being possible for a tension-compression cable or the like to be used.

A particular advantage of the invention arises if the coupling device or the connecting linkage is arranged on the supporting device. This prevents the connecting components which connect the two lock units from being able to collide with other components, such as, for example, roof parts which are to be put away, and a connecting means which would otherwise have to run between the front lock unit and an actuating unit on the vehicle body can therefore be omitted.

Owing to the coupling of the two lock units, it suffices if one of the two lock units has its movement controlled by an actuating device. In this case, one of the two lock units have its movement controlled by a kinematic mechanism which is coupled to a driving device of the supporting device. However, its own controlled drive may also be provided.

In order to carry out the locking movement or to assist such a movement, a prestressing device can be provided which acts on at least one of the two lock units and, for example, prestresses the front closing part into the open position and the rear lock hook into the closed position. A respective end position of the lock units is maintained in a simple manner by the prestressing device.

The prestressing device is preferably neutral in terms of force in the closed position of the front closing part, and therefore a reaction force is not introduced into the two combined lock units.

The prestressing device expediently contains a spring and, in particular, a tension spring which connects the closing part of the front lock unit to the supporting device in such a manner that its force action line is in a dead center position with respect to the closing part when the latter is closed.

A further locking unit is expediently provided for locking the supporting device to the vehicle body, and in this way firm locking is obtained and the supporting device can stiffen the vehicle body in the region of the convertible top storage space. The further locking unit is in each case arranged, for example, on the lateral rear edge region of the supporting device and can be prestressed in the closing direction, for example by a spring which acts on a transmission lever, which is connected between the driving unit and the locking unit, or on a further component of the locking unit, in particular a connecting rod.

A particularly preferred configuration makes provision for the locking unit to form the actuating device of the lock units or a part thereof. The locking unit is expediently actuated by the driving device of the supporting device, and therefore an additional drive is not required for the lock units.

The actuating device for the lock units can expediently be coupled to and decoupled from the lock units. The coupling can therefore be restricted to certain positions of the supporting device in its sequence of movement. In particular, the coupling is undone as soon as the supporting device is to be moved or pivoted upward or rearward from its closed position on the vehicle body. This realizes the advantage according to the invention of not requiring a complicated coupling means which would have to follow the movement of the supporting device and could obstruct the other components or could collide with them. The coupling and decoupling take place, for example, by means of two pivotable coupling parts, with it being possible for one coupling part to be brought into engagement by means of a stop or a recess with a stop or a bolt of the other coupling part.

For the sequence of movement, it is expedient if a blocking device is provided which prevents the driving device of the supporting device from moving back if it is moved in the direction of its second open end position. The blocking device can interact with the bearing device of the supporting device and, in particular, can be activated by it. A simple configuration makes provision for the blocking device to have a locking element which is arranged on the further locking unit and, in particular, on a lock hook of the locking unit and which can be brought into locking engagement with a blocking part arranged on the bearing device of the supporting device.

The bearing device of the supporting device preferably contains a main link, in particular in a four-joint arrangement, which supports the supporting device on the vehicle.

The supporting device is preferably a frame-like supporting structure or a frame which is supported movably on the vehicle body via an articulation device, in particular a four- or multi-joint mechanism, and on which a convertible top compartment cover is mounted pivotably about its front edge.

The driving unit of the supporting device is preferably a linear adjustment unit and, in particular, is a hydraulic piston/cylinder unit.

The supporting device is explained in more detail below using an exemplary embodiment and with reference to the drawing, in which:

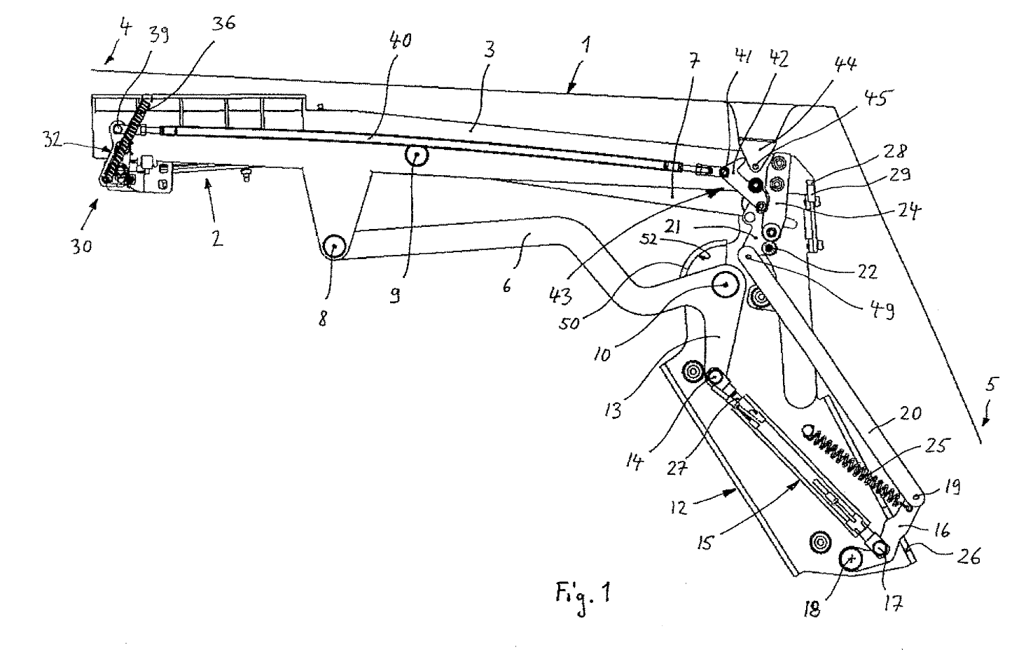

FIG. 1 shows, in a lateral plan view, a supporting device of a convertible top compartment cover of a convertible, which supporting device is arranged in a closed position and is locked to the vehicle body by means of a locking device;

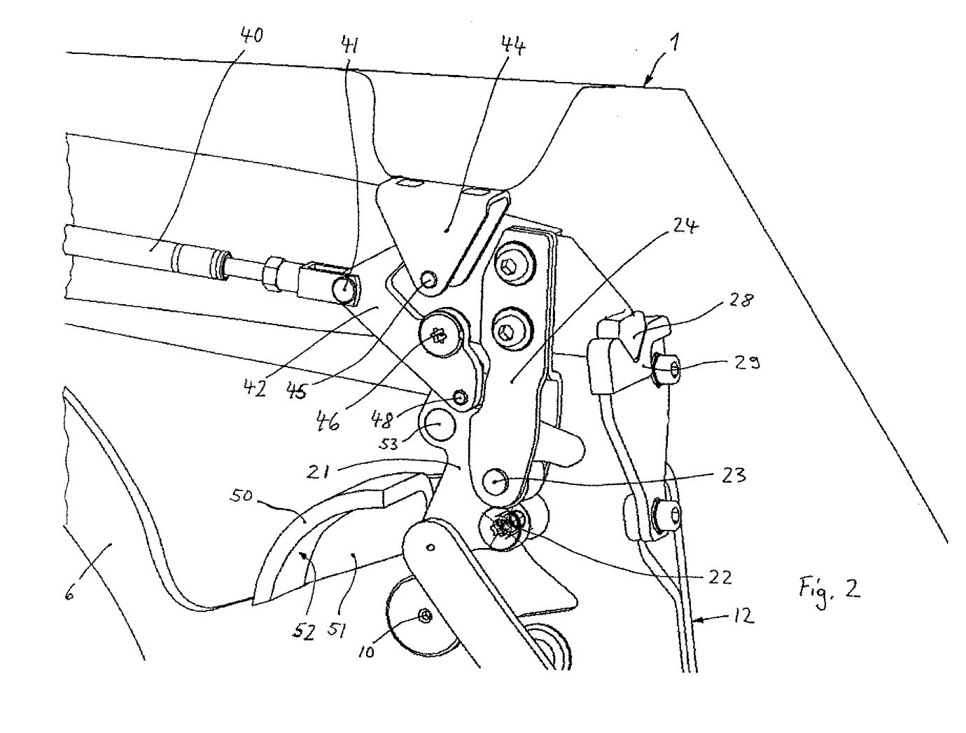

FIG. 2 shows, in a perspective plan view in an enlarged illustration, an open lock unit of the locking device for the convertible top compartment cover and an additional rear lock unit of the supporting device in a closed position;

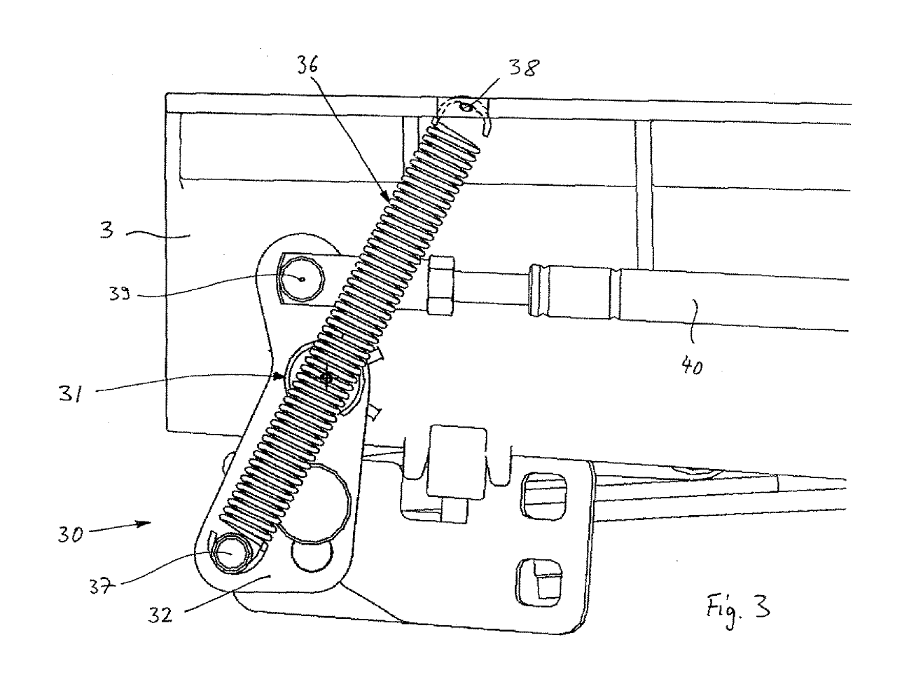

FIG. 3 shows, in a lateral plan view in an enlarged illustration, the first front lock unit in its closed position;

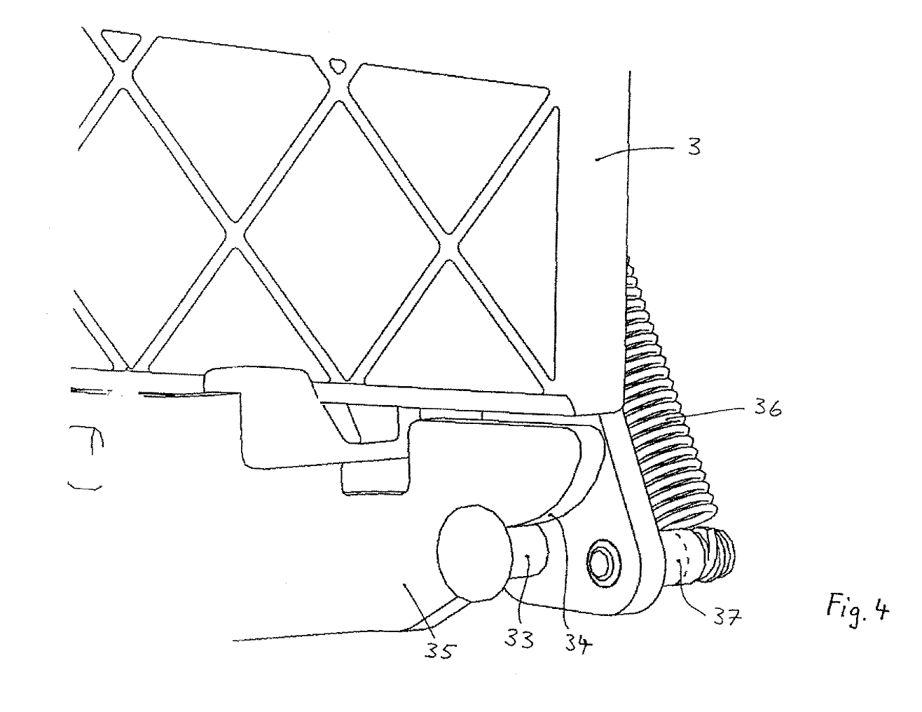

FIG. 4 shows, in a perspective plan view in an enlarged illustration, the front locked lock unit;

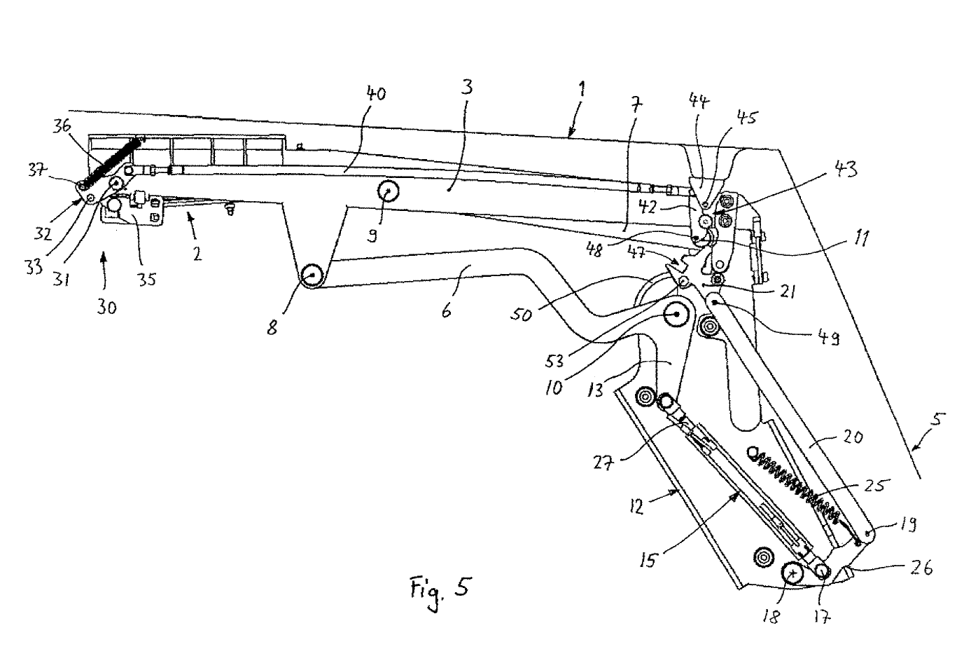

FIG. 5 shows, in a lateral plan view, the supporting device with the convertible top compartment cover in a closed position, the supporting device being unlocked from the vehicle body and the convertible top compartment cover being locked to the supporting device;

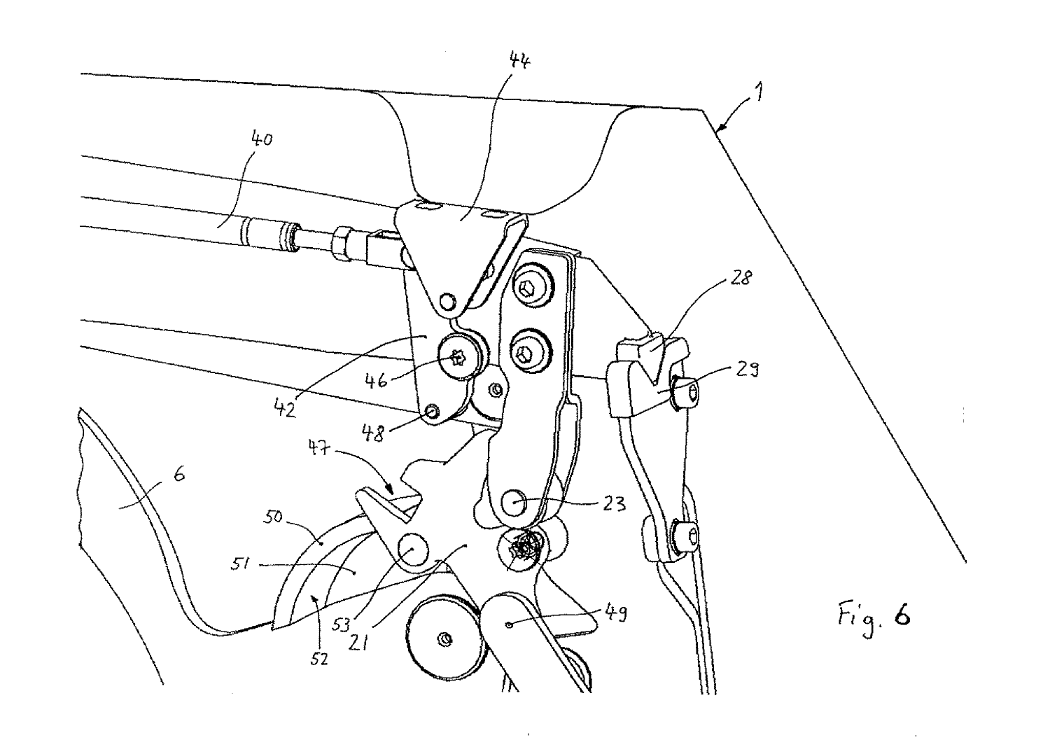

FIG. 6 shows, in a perspective plan view in an enlarged illustration, the locked lock unit of the locking device for the convertible top compartment cover and the second lock unit of the supporting device in an open position;

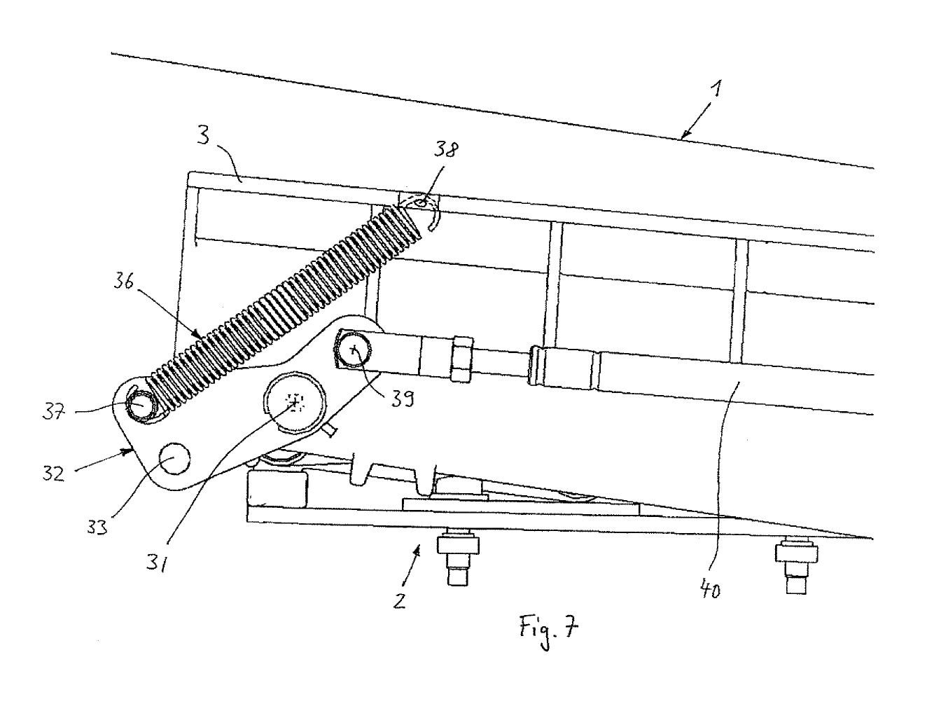

FIG. 7 shows, in a lateral plan view in an enlarged illustration, the first front lock unit in its open position; and

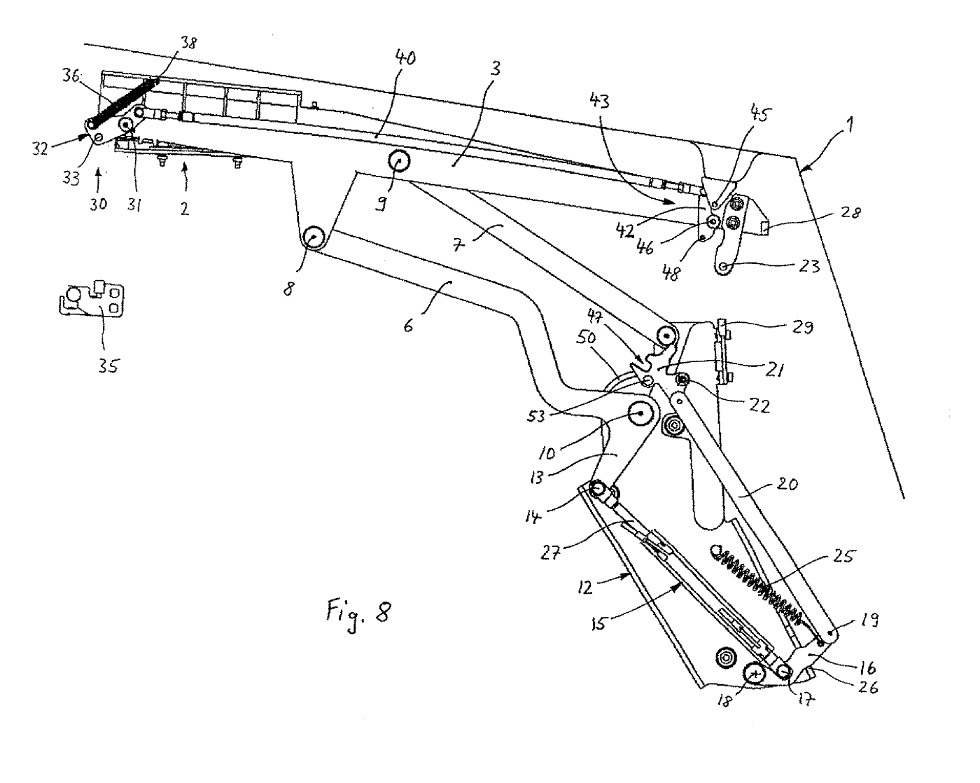

FIG. 8 shows, in a lateral plan view, the supporting device together with the convertible top compartment cover in an intermediate position during the opening of the supporting device, the convertible top compartment cover being locked to the supporting device.

A convertible top compartment cover 1 of a convertible vehicle (not illustrated is mounted on the front side by means of a respective articulation device 2 (not illustrated specifically) on both sides of lateral, front parts of a supporting device, which is formed, for example, as a frame 3, the frame 3 being pivoted to the rear before the collapsible or folding roof is put away in a rear convertible storage space such that the convertible top compartment cover 1 which is fixed to said frame is raised at its front edge 4 and opens up a passage opening for the collapsible or folding roof which is to be put away and which, in particular, can be a hard top roof or a soft top roof. The convertible top compartment cover 1 may also serve as a trunk cover by, when the frame 3 is fixed to the vehicle body, being pivoted up out of its closed position at its rear edge 5 relative to the frame 3 or the vehicle body and therefore opening up a loading opening of the trunk. DE 44 45 944 C1 basically discloses a convertible top compartment cover of this type which is supported via an auxiliary frame mounted on the vehicle rear in a manner such that it can pivot about a pivot axle fixed on the bodywork.

The frame 3 of the convertible top compartment cover 1 is mounted pivotably on both sides of the vehicle body by means of a respective main link 6 and an auxiliary link 7 which form a four-joint mechanism together with the joints 8 and 9 on the frame 3 and the joints 10 and 11 on a bearing plate 12 fixed on the vehicle body. The frame 3 is, for example, of U-shaped design and such that it opens at the front in accordance with the auxiliary frame disclosed in DE 44 45 944 C1.

The main link 6 has a bent extension 13 which extends beyond the joint 10, which forms a pivot or bearing axis, with a drive unit in the form of, for example, a hydraulic piston/cylinder unit 15 being coupled on the end side of the extension in a Joint 14. The piston/cylinder unit 15 is supported at the other end on a transmission lever 16 in a joint or articulation point 17 which is arranged between the pivot mounting 18 of the transmission lever 16 on the nearing plate 12 and its opposite end to which a connecting rod 20 is coupled in a joint 19. The connecting rod 20 extends upward to a lock hook 21 of a rear lock or locking unit which fixes the frame 3 in its end position or closed position on Ace bodywork or on the bearing plate 12 fixed on the bodywork. The lock hook 21 is mounted pivotably about a pivot axis 22 on the vehicle body and engages behind a bolt 23 which is fastened to a support part 24 which protrudes downward from the frame 3.

A tension spring 25 is fastened, firstly, to the transmission lever 16 in the vicinity of the joint 19 of the connecting rod 20 and, secondly, to the bearing plate 12 and prestresses the transmission lever 16 and therefore the rear locking unit into a closed position. A stop 26 which is fixed on the vehicle body and is formed, for example, on the bearing plate 12 restricts the pivoting distance of the transmission lever 16 in the opening direction counter to the direction of force of the tension spring 25.

In the closed position of the convertible top compartment cover 1 and of the frame 3 (see FIG. 1), the piston/cylinder unit 15 is unpressurized when the piston rod 27 is retracted. The tension spring 25 uses the connecting rod 20 to clamp the lock hook 21 in its locking position in which it keeps the bolt 23, which may be surrounded by a sleeve, locked in a manner fixed on the vehicle body. A downwardly tapering guide part 28 of the frame 3 is accommodated in a centered manner in a corresponding receptacle 29 on the vehicle body, thus forming a y-z support (in the x-y-z coordinate system) of the frame 3 while the lock hook 21 permits an x support.

The frame 3 furthermore contains, on its respective lateral front section, a front locking unit 30 with a closing part 32 which is mounted pivotably in a point 31 and has a locking bolt 33 for locking engagement on a locking guide slot 34 of a lock part 35, which is fixed on the vehicle body, when the frame 3 is arranged in its closed position A tension spring 36 as arranged, firstly, on a retaining peg 37, which is attached to the closing part 32 in the region of the locking bolt 33, and, secondly, on a pin 38, which is attached to the frame 32 in the region above the front locking unit 30, in such a manner that its spring action line (straight line through the fastenings 37 and 38) runs through the pivot axis, which is defined by the joint 31, of the closing part 32, when the closing part 32 is closed (FIGS. 1, 3 and 4), and therefore assumes a dead center position in which it does not apply any adjustment force to the closing part 32.

A connecting linkage 40 which is coupled at one end to the closing part 32 in a joint 39 is coupled at the other end in a joint 41 to a lock hook 42 of a closure unit 43 which is arranged in the region of the lock hook 21 of the rear locking unit of the frame 3 and is provided for the locking of the convertible top compartment cover 1. For this purpose, the convertible top compartment cover 1 contains a downwardly protruding lock clamp 44 with a locking bolt 45 on which the lock hook 42, which is pivotable about a pivot axis 46, can be brought into locking engagement.

The controlling of the movement of the lock hook 42 and therefore of the combination locking formed by the front locking unit 30 and the rear closure unit 43 takes place by means of a recess 47 (see, for example, FIGS. 5 and 6) which is formed on the lock hook 21, which forms a rotary latch, and, when the open lock hook 21 is pivoted into its closed position, receives and forcibly guides a bolt 48 of the lock hook 42, as a result of which the lock hook 42 is pivoted.

In the closed position of the frame 3 and of the convertible top compartment cover 1 that is illustrated in FIGS. 1 and 2, the rotary latch or the lock hook 21 keeps the closure hook 42 and the closing part 32 coupled thereto in a position in which the front locking unit 30 is arranged in its closed position on the lock part 3S, which is fixed on the vehicle body (also see FIGS. 3 and 4), and therefore the frame 3 is also held securely at the front on the vehicle body. The tension spring 36 which is arranged in a dead center position is neutral in terms of force with respect to the closing part 32 and therefore also does not act counter to the tension spring 25 which keeps the cylinder housing of the piston/cylinder unit 15 positioned in the unpressurized state.

The rear lock hook 42 is arranged in its pivoted-back open position in which it opens up the lock clamp 44 of the convertible top compartment cover 1. In its function as a rear cover or trunk cover, the convertible top compartment cover 1 is now pivoted up by its rear edge 5, with it being possible for at least one gas-filled compression spring (not illustrated) which is connected in between to assist the pivoting-up operation.

In order to pivot the convertible top compartment cover 1 together with the frame 3 to the rear and therefore to open up the path for retraction or extension of the convertible top into or out of the storage space, the piston/cylinder unit 15 is subjected to pressure such that it extends by extension of its piston rod 27. The piston or expansion force first of all causes the transmission lever 16 to pivot downward counter to the force of the tension spring 25 as far as the stop 26, since, on account of the weight of the frame 3 and of the convertible top compartment cover 1, the main link 6 exerts a counterforce on the piston/cylinder unit 15, which counterforce is greater than the adjustment force required to pivot the transmission lever 16 and the locking device coupled thereto.

The piston/cylinder unit 15 is coupled with its articulation point 17 substantially closer to the pivot mounting 18 of the transmission lever 16 than to the joint 19 of the connecting rod 20, and therefore, in accordance with the design undertaken, for example an increase in the transmission ratio of the movement distance of the piston/cylinder unit 15 in relation to the connecting rod 20 by a factor of 4 is produced. For a certain length of the adjustment distance of the connecting rod 20, for example for 20 mm, only a 5 mm movement distance of the piston/cylinder unit 15 is therefore required. The increase in the transmission ratio of the movement distance results at the same time in a corresponding reduction of the actuating force of the piston/cylinder unit 15 to the connecting rod 20 to the same extent, as a result of which the components can be dimensioned to be smaller and therefore can be constructed to be lighter. Furthermore, in the event of blocking of the movement of the main link 6 or of the locking unit 21, the high adjustment forces of the hydraulic piston/cylinder unit 15 are reduced by the extent of the transmission ratio at the locking unit, thus enabling more serious damage to be avoided.

A joint 49 which connects the connecting rod 20 to the lock hook 21 is arranged on said lock hook in such a manner that, on account of the movement distance of the connecting rod 20, the lock hook 21 can execute the required pivoting movement between the open position and the closed position.

When the lock hook 21 is unlocked (see FIG. 5), the transmission lever 16 or else another component of the locking kinematics bears on a or on the stop 26 such that, via the joint 14, the further extension of the piston rod 27 adjusts the main link 6 in the opening direction (movement from the position of FIG. 2 to the position of FIG. 8).

The lock hook 21 which pivots into its open position initially pivots, via its recess 47, the bolt 48 and therefore the lock hook 42 in the direction of its closed position and, via the coupling of the connecting linkage 14, pivots the closing part 32 of the front locking unit 30 into its open position. When the closing part 32 is pivoted into its open position, the retaining peg 37 pivots the tension spring 36 out of its dead center position into an active position in which its tensile force (see FIG. 5) brings about the opening movement of the closing part 32 and at the same time, via the coupling of the connecting linkage 40, also the closing movement of the lock hook 42 into their end positions. The frame 3 is therefore released at its front edge for raising while the convertible top compartment cover 1 is secured on the frame 3.

An annular segment 50 which is concentric with respect to the bearing axis 10 is fastened to the main link 6 in the region of its bearing axis 10 by means of a supporting plate 51, which is attached fixedly to the main link 6, in such a manner that, by means of its inner supporting path 52, the annular segment 50 begins, in the position of FIG. 5, to engage behind a supporting bolt 53 protruding from the lock hook 21 laterally toward the bearing plate 12. By means of the annular segment 50, which forms a blocking guide slot, the lock hook 21 is blocked against pivoting in the closing direction and, as a result, that end of the piston/cylinder unit 15 which is mounted on the transmission lever 16 is held by it in a positionally fixed manner even if an undesirable load or counterforce acts on the opening convertible top compartment cover 1 and/or frame 3.

Further extension of the piston rod 27 pivots the main link 6 via the intermediate position illustrated in FIG. 8 into its open end position in which the frame 3 is pivoted together with the convertible top compartment cover 1 to the rear and therefore an opening for the retraction or extension of the convertible top is opened up. The transmission lever 16 bears against the stop 26, and the lock hook 21 provides an opposite support via its engagement on the annular segment 50. The lower articulation point 17 of the piston/cylinder unit 15 is therefore kept in a fixed position. If, in the open position, the frame 3 together with the convertible top compartment cover 1 assumes a position beyond the dead center with respect to its mounting, i.e. if the center of gravity of the unit comprising frame 3 and convertible top compartment cover 1 has moved to the rear beyond the bearing axis and the unit bears, for example, against a support, the piston/cylinder unit 15 can be switched to unpressurized.

The unpressurized switching of the piston/cylinder unit 15 can also take place in the closed position according to FIG. 1. By means of the tension spring 25, the rear locking unit and the lock hook 21 are then prestressed into the closed position such that, because of the weight of the cylinder housing of the piston/cylinder unit 15, the lock hook 21 cannot open even in the event of being shaken during driving.

The locking of the convertible top compartment cover 1 by means of the lock hook 42 on the frame 3 prevents the convertible top compartment cover 1 from pivoting open at its rear edge 5 if the rearwardly pivoting frame 3 raises the articulation device 2 of the convertible top compartment cover 1 and the effective weight of the convertible top compartment cover 1, which is positioned obliquely in this case, as a counterforce to the opening force applied by the gas-filled compression spring decreases.

The closing of the convertible top compartment cover 1 and/or of the frame 3 takes place in an opposed sequence of movement by retraction of the piston rod 27 of the piston/cylinder unit 15. In this case, upon further retraction of the piston rod 27 out of the position according to FIG. 5, the transmission lever 16 is pivoted upward (in the anticlockwise direction according to FIG. 5) as soon as the supporting bolt 53 is released from the blocking guide slot or the annular segment 50, and the lock hook 21, in engagement with the bolt 23, draws the frame 3 into its end position, with the guide part 28 being held centrally in the receiving part 29.

At the same time, the lock hook 21, by means of its recess 47, grasps the bolt 48 of the lock hook 42 and pivots the latter into its open position (FIG. 1) in which it opens the locking bolt 45 of the locking of the convertible top compartment cover 1. The lock hook 42 uses the connecting linkage 40 to pivot the closing part 32 counter to the force of the tension spring 36 into its closed position in which the tension spring 36 is arranged in its dead center position.

### LIST OF REFERENCE NUMBERS

1 Convertible top compartment cover
2 Articulation device
3 Frame
4 Front edge
5 Rear edge
6 Main link
7 Auxiliary link
8 Joint
9 Joint
10 Joint
11 Joint
12 Bearing plate
13 Extension
14 Joint
15 Piston/cylinder unit
16 Transmission lever
17 Articulation point
18 Pivot mounting
19 Joint
20 Connecting rod
21 Lock hook
22 Pivot axis
23 Bolt
24 Support part
25 Tension spring
26 Stop
27 Piston rod
28 Guide part
29 Receptacle
30 Front locking unit
31 Joint
32 Closing part
33 Locking bolt
34 Locking guide slot
35 Lock part
36 Tension spring
37 Retaining peg
38 Pin
39 Joint
40 Connecting linkage
41 Joint
42 Lock hook
43 Closure unit
44 Lock clamp
45 Locking bolt
46 Pivot axis
47 Recess
48 Bolt
49 Joint
50 Annular segment
51 Supporting plate
52 Supporting path
53 Supporting bolt

1. A supporting device for a convertible top compartment cover of a convertible, which supporting device is mounted movably on the vehicle body and can be fixed on the vehicle body by means of a locking device, characterized in that the locking device has two lock units which are connected to each other for common actuation and are arranged on the supporting device, the first lock unit being provided for fixing the supporting device to the vehicle body and the second lock unit being provided for fixing the convertible top compartment cover which is mounted movably on the supporting device to the supporting device.

2. The supporting device of claim 1, characterized in that, in a closed position of the supporting device, the first lock unit locks the supporting device to the vehicle body and the second lock unit unlocks the convertible top compartment cover.

3. The supporting device of claim 1, characterized in that a coupling device, in particular a connecting linkage, couples the two lock units to each other.

4. The supporting device of claim 3, characterized in that the coupling device or the connecting linkage is arranged on the supporting device.

5. The supporting device of claim 1, characterized in that one of the two lock units has its movement controlled by an actuating device.

6. The supporting device of claim 5, characterized in that the actuating device has a driving part, which is mounted movably or pivotably on the vehicle body, and a driven part which is mounted movably or pivotably on the supporting device and to which the driving part can be coupled or from which the driving part can be decoupled.

7. The supporting device of claim 1, characterized in that one of the two lock units has its movement controlled by a kinematic mechanism which is coupled to a driving device of the supporting device.

8. The supporting device of claim 1, characterized in that a prestressing device acts on at least one of the two lock units and prestresses the front closing part into the open position and the rear lock hook into the closed position.

9. The supporting device of claim 8, characterized in that the prestressing device is neutral in terms of force in the closed position of the front closing part.

10. The supporting device of claim 8, characterized in that the prestressing device contains a tension spring which connects the closing part to the supporting device in such a manner that its force action line is in a dead center position with respect to the closing part when the latter is closed.

11. The supporting device of claim 1, characterized in that a further locking unit is provided for locking the supporting device to the vehicle body.

12. The supporting device of claim 11, characterized in that the locking unit is prestressed in the closing direction.

13. The supporting device of claim 11, characterized in that the locking unit is prestressed by a spring which acts on the transmission lever or on a further component of the locking unit, in particular a connecting rod.

14. The supporting device of claim 11, characterized in that the actuating device of the lock units contains the locking unit or is formed by the latter.

15. The supporting device of claim 14, characterized in that the actuating device of the lock units can be coupled to and decoupled from the lock units.

16. The supporting device of claim 1, characterized in that, on the locking side, at least one stop which is fixed on the vehicle is provided in one of the directions of movement of a driving device of the supporting device.

17. The supporting device of claim 1, characterized in that a blocking device is provided which prevents the driving device of the supporting device from moving back if it is moved in the direction of its second end position.

18. The supporting device of claim 17, characterized in that the blocking device interacts with the bearing device of the supporting device and, in particular, is activated by it.

19. The supporting device of claim 17, characterized in that the blocking device has a blocking element which is arranged on the locking unit and, in particular, on a lock hook of the locking unit and can be brought into blocking engagement with a blocking part arranged on the bearing device of the supporting device.

20. The supporting device of claim 1, characterized in that the supporting device is supported on the vehicle by means of a main link, in particular in a four-joint arrangement.

21. The supporting device of claim 1, characterized in that a lock hook of the locking unit draws the supporting device in the closed position into a y-z support fixed on the vehicle.

22. The supporting device of claim 1, characterized in that the supporting device is a frame which is supported movably on the vehicle body via an articulation device, in particular a four- or multi-joint mechanism, and on which a convertible top compartment cover is pivotably mounted.

23. The supporting device of claim 1, characterized in that the driving unit, is a linear adjustment unit and, in particular, is a hydraulic piston/cylinder unit.
